(19) United States
(12) Patent Application Publication
(10) Pub. No.: US 2018/0007404 A1
(43) Pub. Date: Jan. 4, 2018

(54) VIDEO CREATION SERVER, VIDEO CREATION PROGRAM, VIDEO CREATION METHOD, AND VIDEO CREATION SYSTEM

(71) Applicant: CREA-JAPAN INC., Shibuya-ku (JP)

(72) Inventors: Tomochika NANNO, Shibuya-ku (JP); Katsuhiko WATANABE, Shibuya-ku (JP); Hiroshi NAKAZAWA, Shibuya-ku (JP)

(73) Assignee: CREA-JAPAN INC., Shibuya-ku (JP)

(21) Appl. No.: 15/541,878

(22) PCT Filed: Nov. 24, 2015
(86) PCT No.: PCT/JP2015/005834

§ 371 Date: Jul. 6, 2017

(30) Foreign Application Priority Data
Jan. 7, 2015 (JP) 2015-001397

(51) Int. Cl. H04N 21/234; H04N 21/83; G06F 17/30; H04N 21/854; G06F 17/21

(52) U.S. Cl. CPC H04N 21/23418; H04N 21/854; G06F 17/21; G06F 17/30867; H04N 21/83

(57) ABSTRACT

A technique for presenting text information to service users with enhanced visual effects so that the text information makes a strong impression on the users. A video creation server includes an acquisition section configured to acquire material data including one or both of text data and a still image, and a control section configured to acquire a script code editable by a user and to create moving-image data having the material data embedded into each frame of previously defined moving-image data such that the material data moves within the previously defined moving-image data in accordance with the script code.

### TECHNICAL FIELD

The present invention relates to a technique for embedding material data such as text data and still images into moving-image data.

### BACKGROUND ART

Internet users routinely deliver moving images which they created or took. The moving images have various formats including Flash Video, MPEG 4, WebM, and AVI.

There are systems which accumulate and process personal data about service users and provide the personal data to each service user in response to a user request or at a predetermined date and time. There are also systems which provide statistic data or the like created on the basis of personal data. Those systems provide such data through delivery over networks including the Internet, media including optical disks, hand delivery of paper, or mail.

The following documents have been disclosed in the related art.

### PRIOR ART DOCUMENT

### Patent Document

[Patent Document 1] Japanese Patent Laid-Open No. 2007-66303

### DISCLOSURE OF THE INVENTION

### Problems to be Solved by the Invention

For example, in presenting text information such as personal data to users, mere presentation of character stings, enumeration of data, and lists do not appeal visually to service users.

One of problems to be solved by the invention relates to providing a technique for presenting text information to service users with enhanced visual effects so that the text information makes a strong impression on the users. It is an object of the invention to provide a technique for creating different data to be presented to different service users and facilitating the creation of such data.

### Means for Solving the Problems

According to an embodiment, a video creation server includes an acquisition section configured to acquire material data including one or both of text data and a still image, and a control section configured to acquire a script code editable by a user and to create moving-image data having the material data embedded into each frame of previously defined moving-image data such that the material data moves within the previously defined moving-image data in accordance with the script code.

According to an embodiment, a video creation program is provided for causing a computer to perform processing including: acquiring material data including one or both of text data and a still image; acquiring a script code editable by a user; and creating moving-image data having the material data embedded into each frame of previously defined moving-image data such that the material data moves within the previously defined moving-image data in accordance with the script code.

According to an embodiment, a video creation method includes performing, by a computer, processing of: acquiring material data including one or both of text data and a still image; acquiring a script code editable by a user; and creating moving-image data having the material data embedded into each frame of previously defined moving-image data such that the material data moves within the previously defined moving-image data in accordance with the script code.

According to an embodiment, a video creation system includes a first server and a second server. The first server is configured to acquire material data including one or both of text data and a still image, to acquire a script code editable by a use, and to create moving-image data having the material data embedded into each frame of previously defined moving-image data such that the material data moves within the previously defined moving-image data in accordance with the script code. The second server is configured to acquire the moving-image data having the embedded material data created by the first server and to deliver the moving-image data to a provider of personal data included in the moving-image data.

The video creation server, program, method, and system described above can synthesize voice in previously defined moving-image data and a voice material in accordance with the script code.

### Advantage of the Invention

The information can be presented with enhanced visual effects so that the information makes a strong impression on the service users.

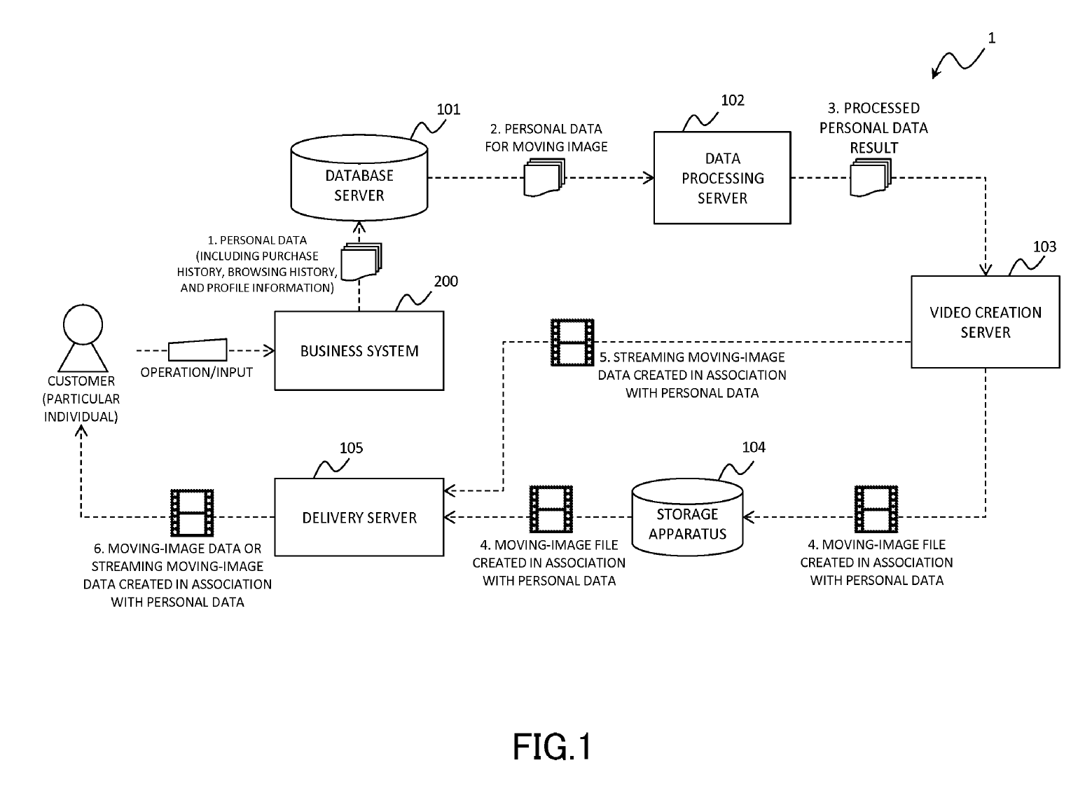

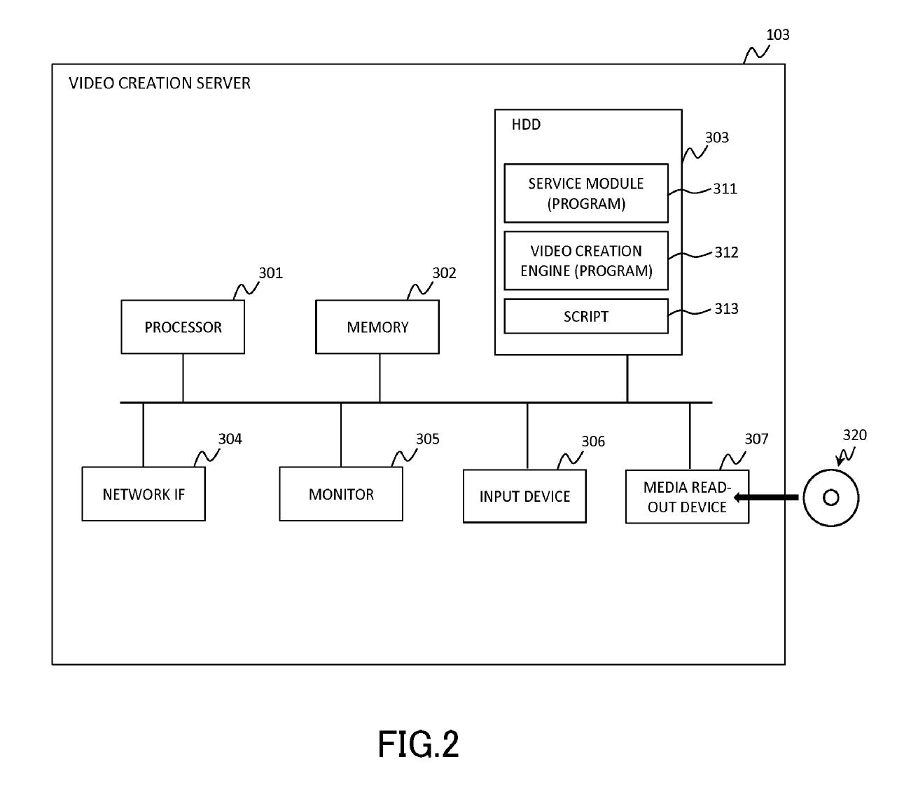

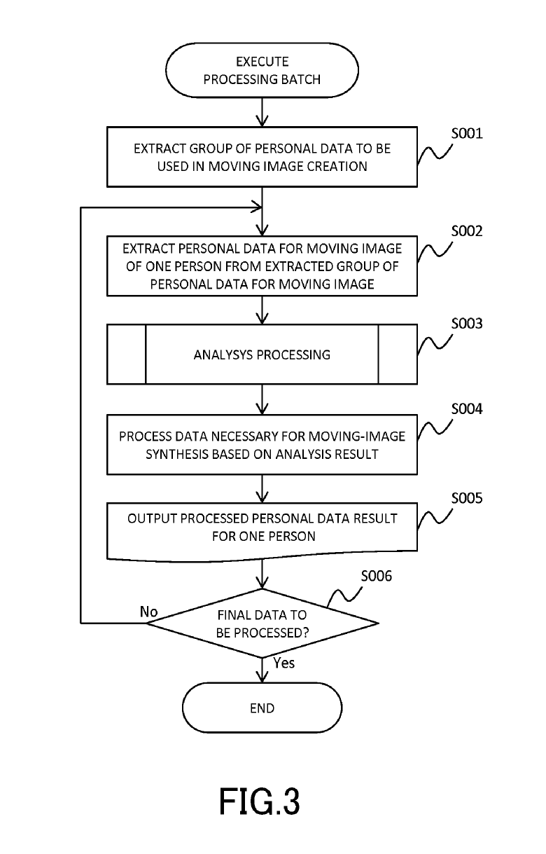

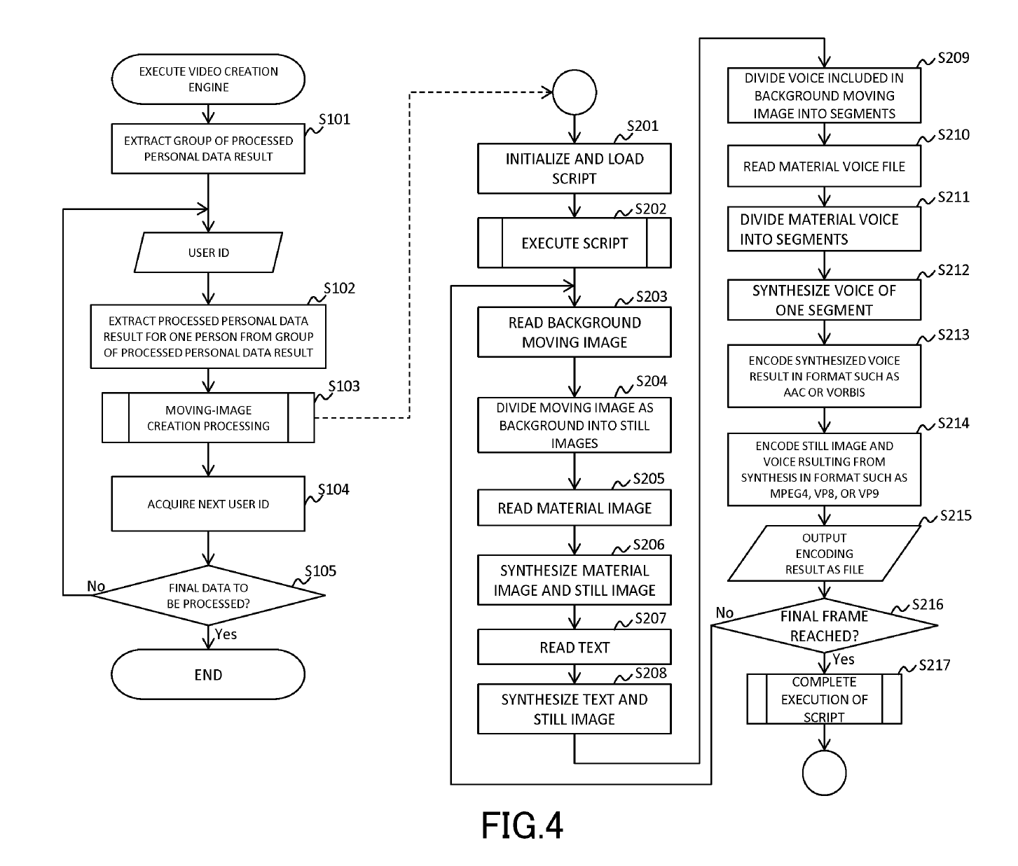

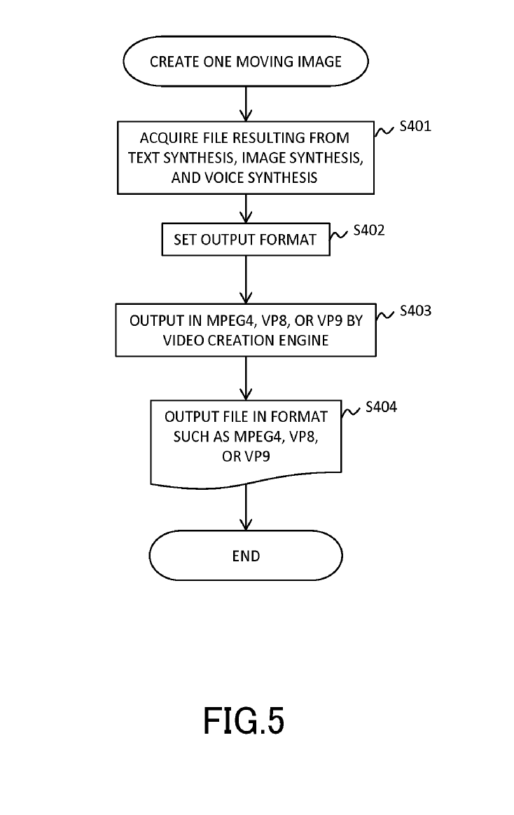

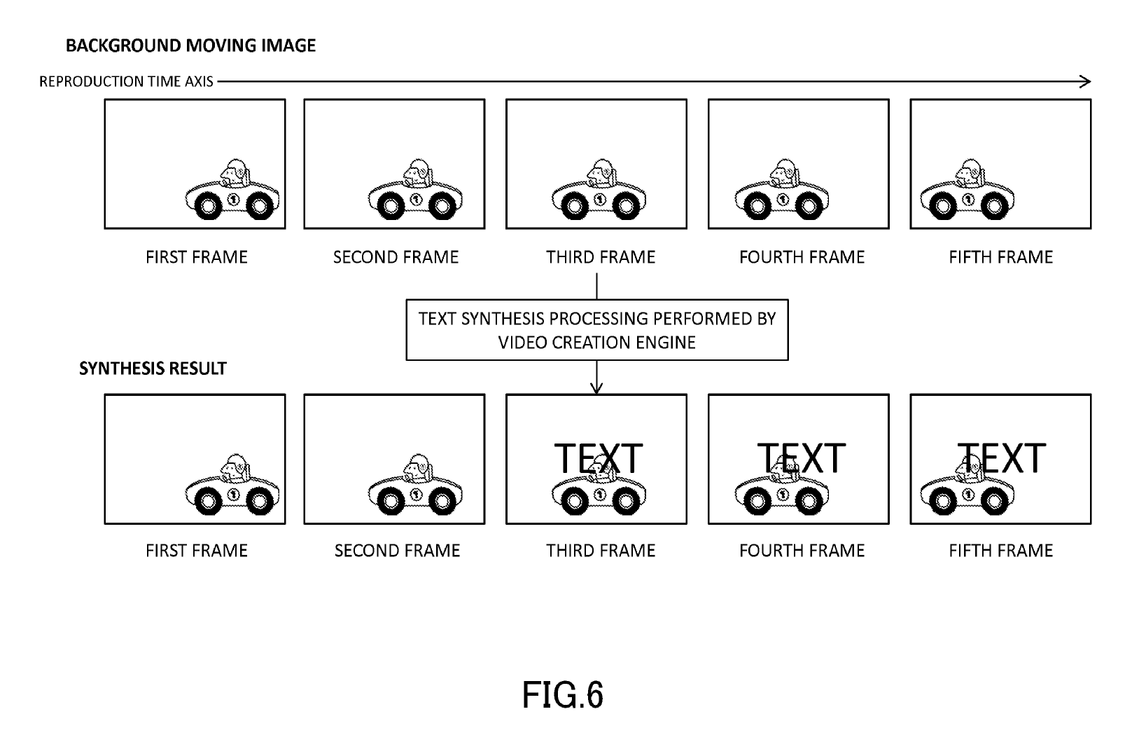

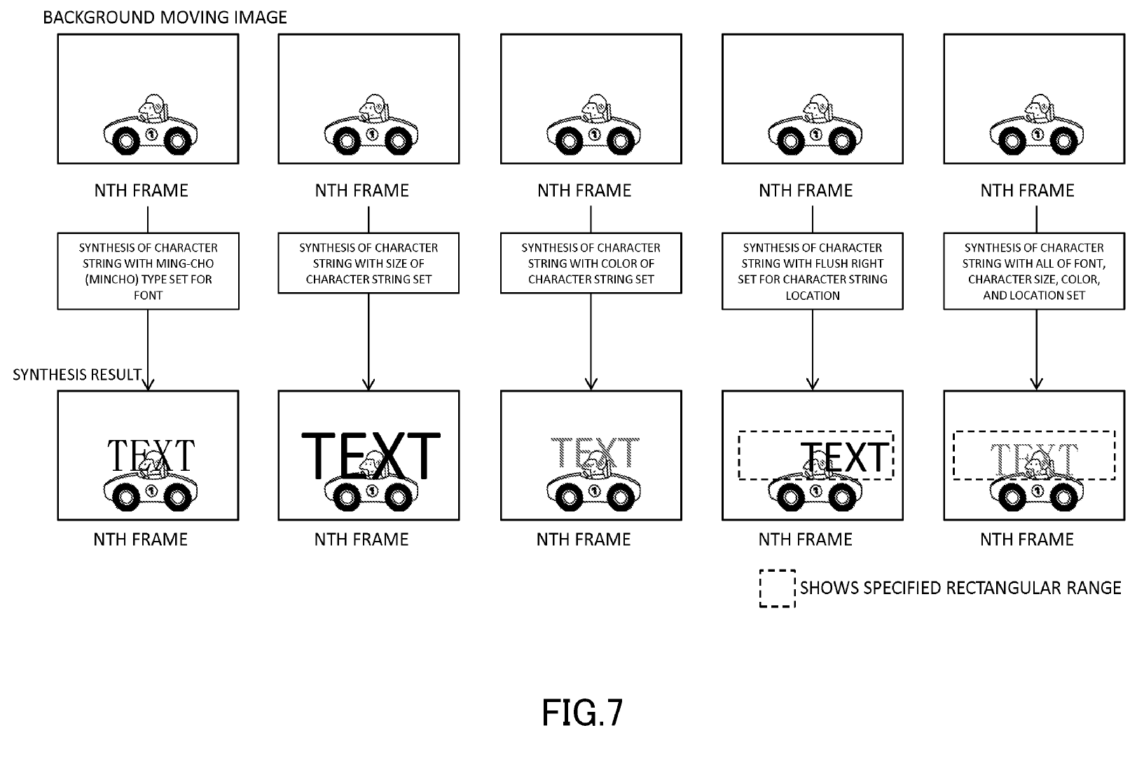

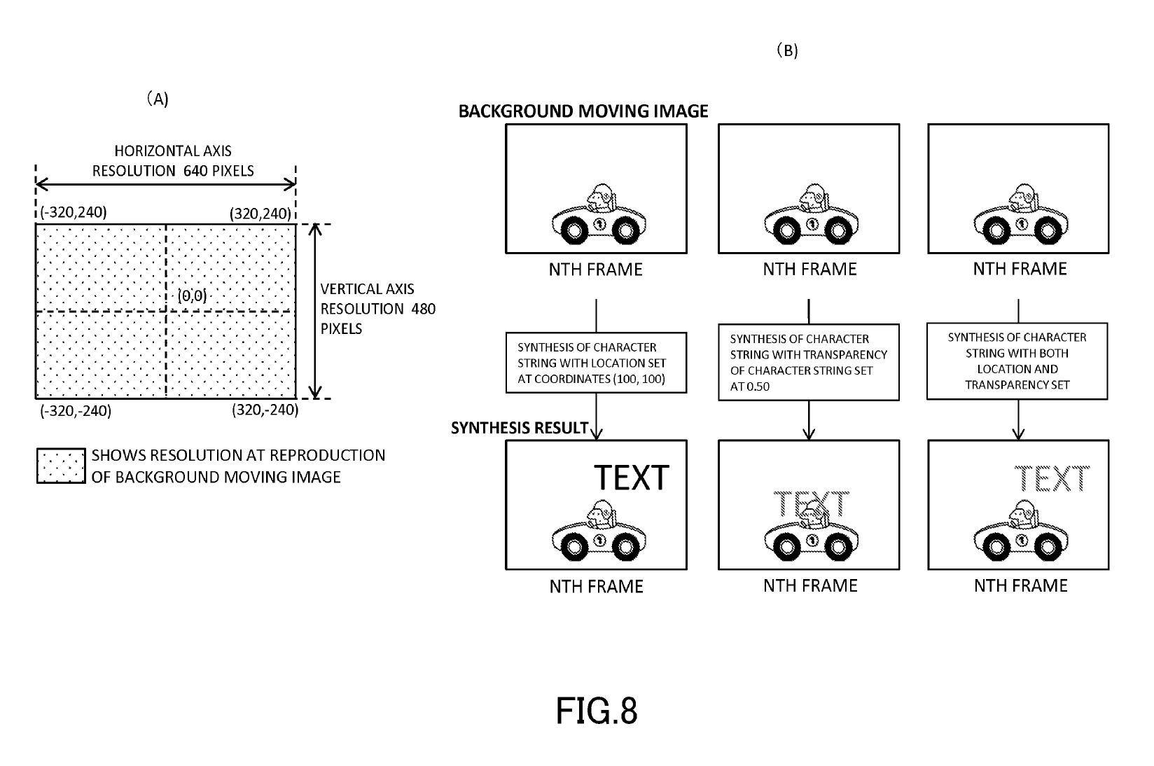

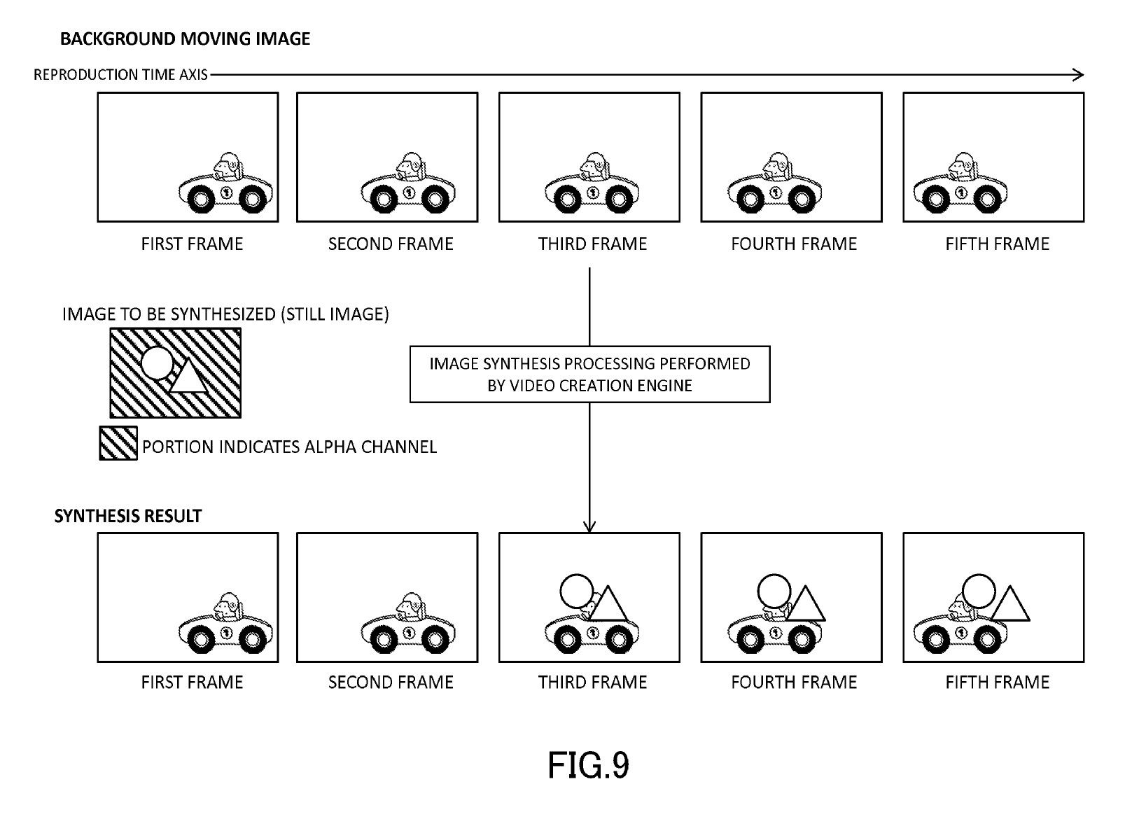

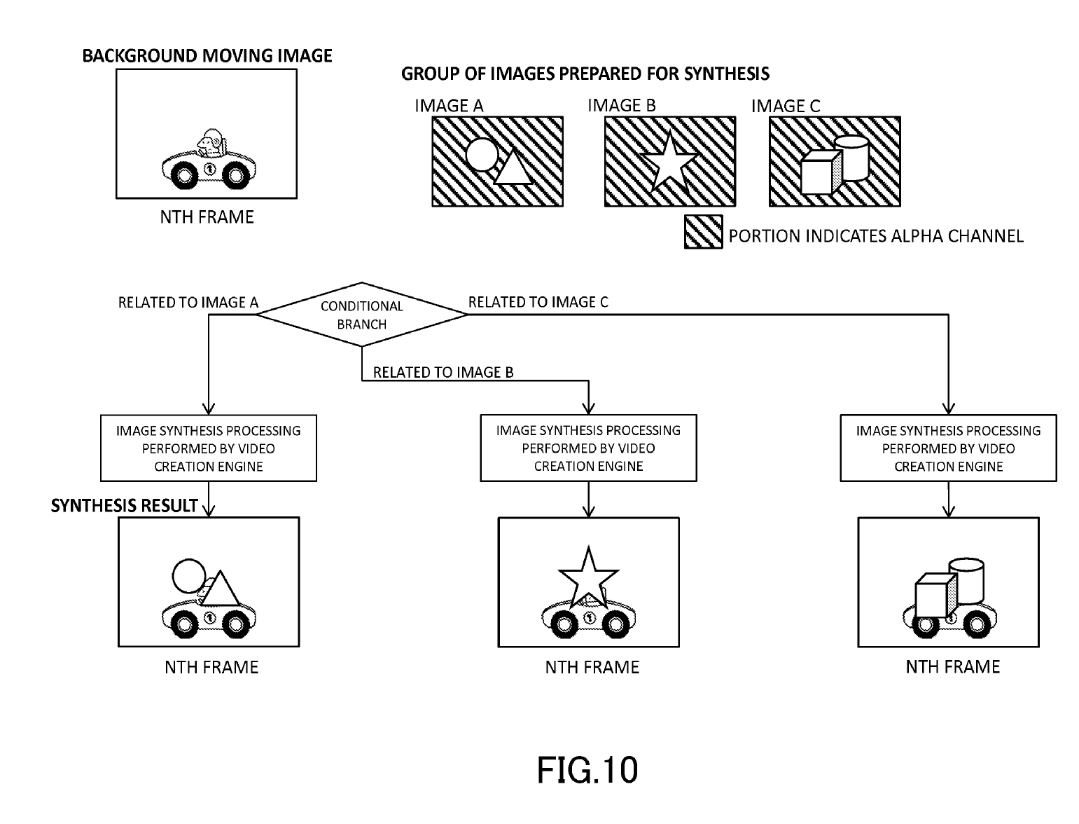

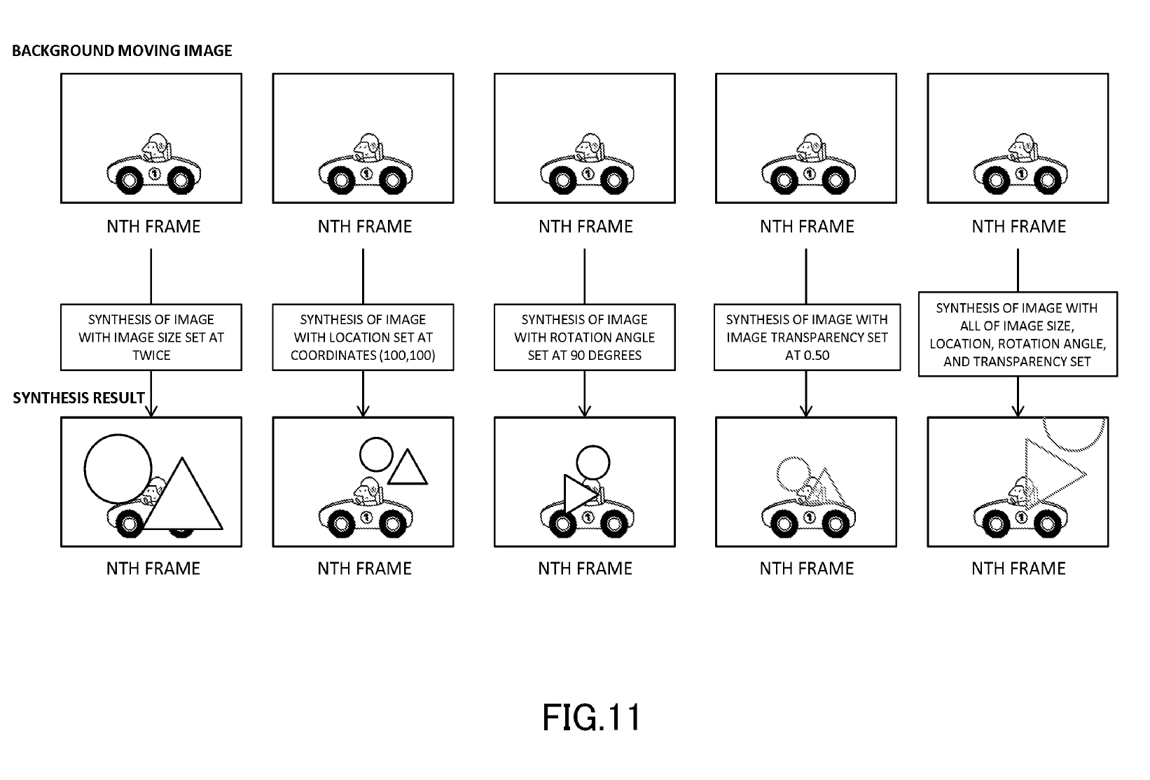

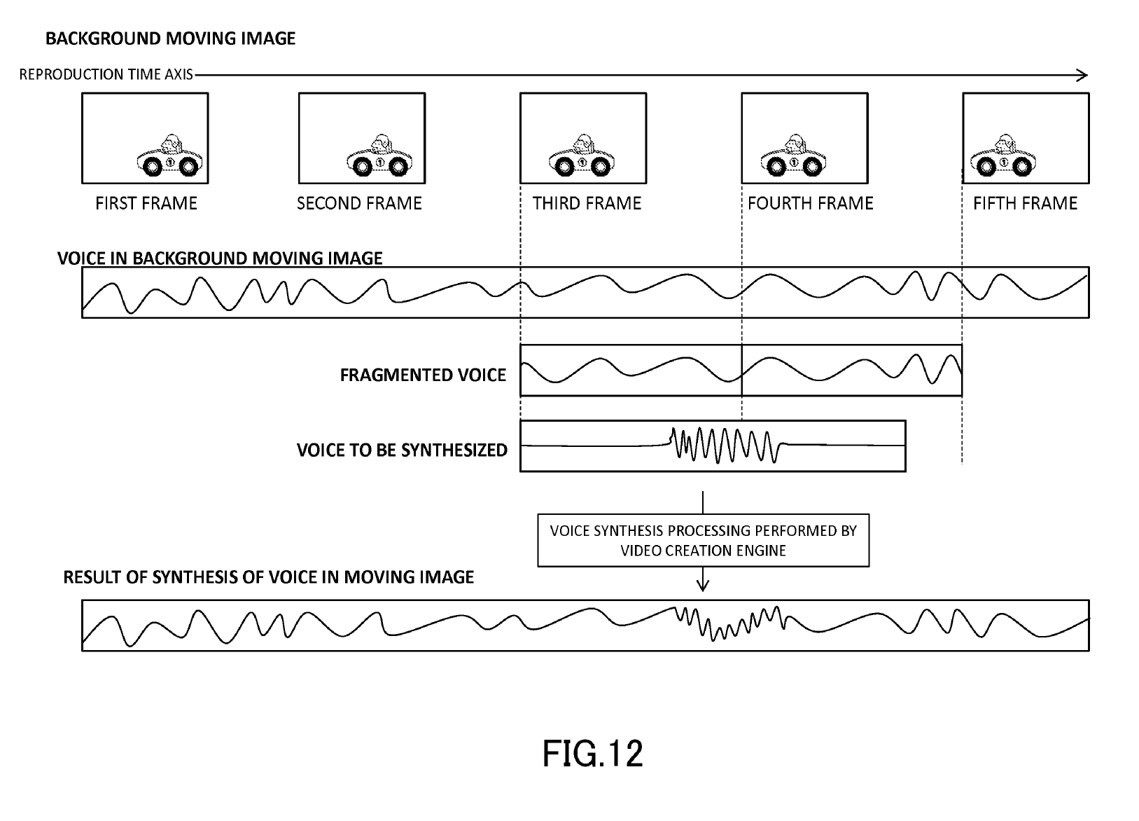

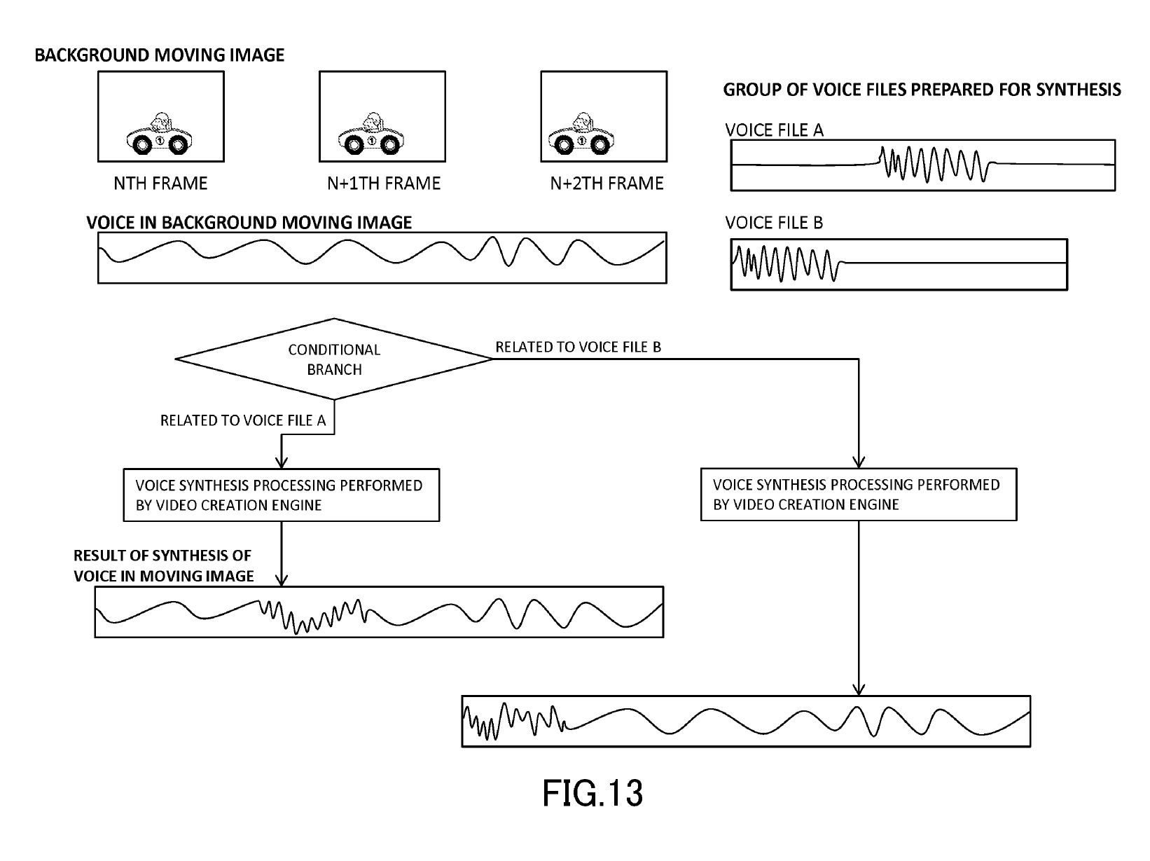

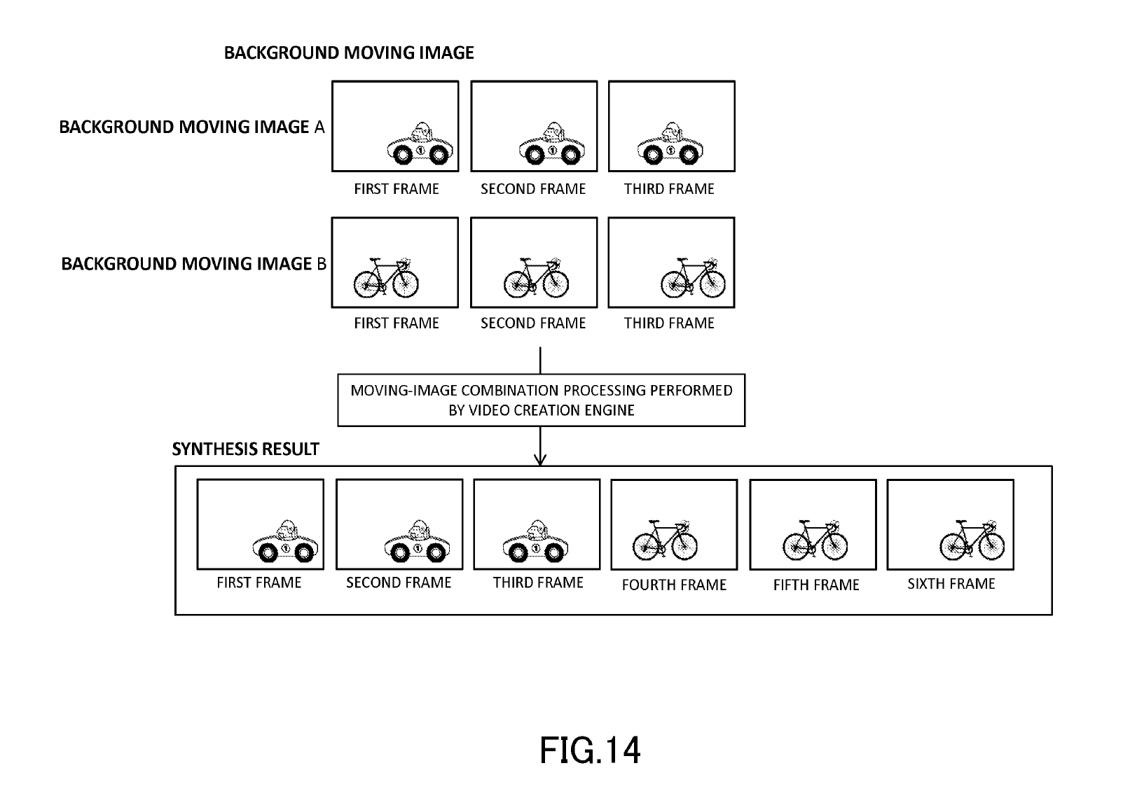

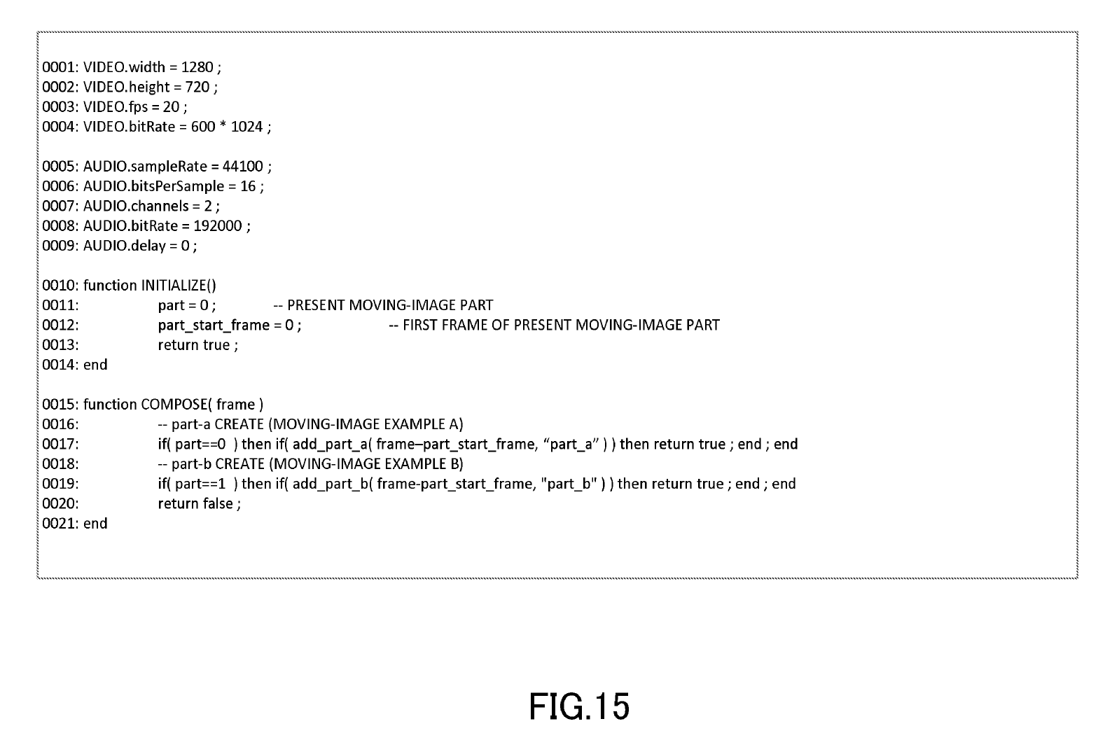

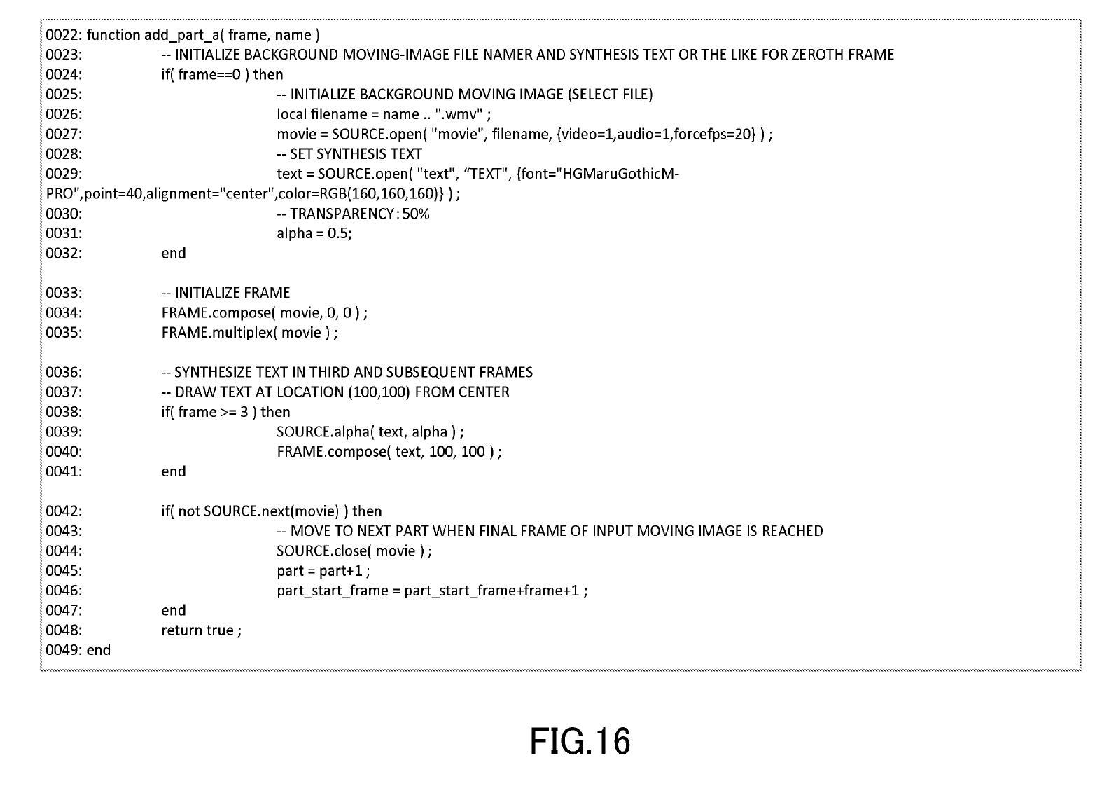

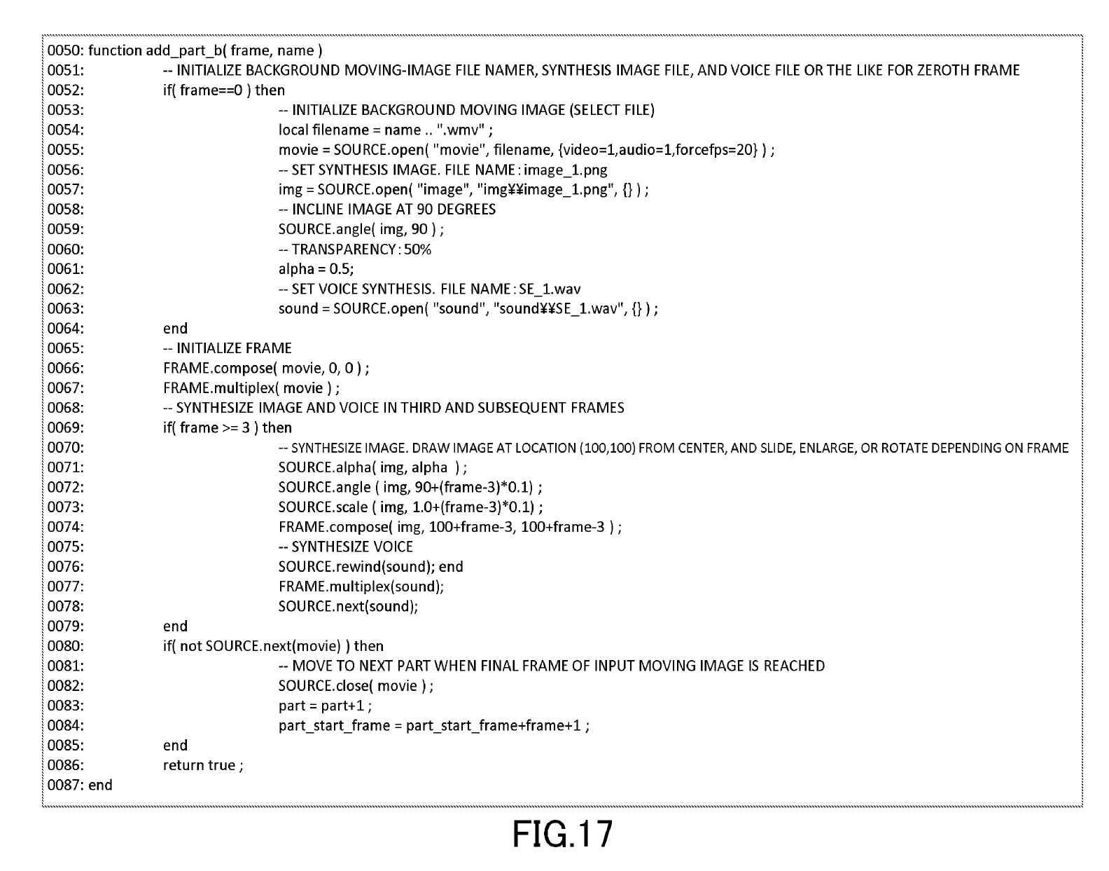

### BRIEF DESCRIPTION OF THE DRAWINGS

[FIG. 1] A diagram showing an exemplary configuration according to an embodiment.

[FIG. 2] A block diagram showing an exemplary internal configuration of a video creation server according to the embodiment.

[FIG. 3] A flow chart showing an exemplary operation of a data processing server according to the embodiment.

[FIG. 4] A flow chart showing an exemplary operation of the video creation server according to the embodiment.

[FIG. 5] A flow chart showing an exemplary operation of output of a single file performed by a video creation engine according to the embodiment.

[FIG. 6] A diagram for explaining character synthesis processing performed by the video creation engine according to the embodiment.

[FIG. 7] A diagram for explaining character synthesis processing performed by the video creation engine according to the embodiment.

[FIG. 8] A diagram for explaining character synthesis processing performed by the video creation engine according to the embodiment.

[FIG. 9] A diagram for explaining image synthesis processing performed by the video creation engine according to the embodiment.

[FIG. 10] A diagram for explaining image synthesis processing performed by the video creation engine according to the embodiment.

[FIG. 11] A diagram for explaining image synthesis processing performed by the video creation engine according to the embodiment.

[FIG. 12] A diagram for explaining voice synthesis processing performed by the video creation engine according to the embodiment.

[FIG. 13] A diagram for explaining voice synthesis processing performed by the video creation engine according to the embodiment.

[FIG. 14] A diagram for explaining moving-image combination processing performed by the video creation engine according to the embodiment.

[FIG. 15] A diagram showing an example of a script.

[FIG. 16] A diagram showing an example of the script.

[FIG. 17] A diagram showing an example of the script.

### MODE FOR CARRYING OUT THE INVENTION

A system according to an embodiment creates and delivers moving images personalized (personalized videos) for individuals based on their personal data stored in a database. The system according to the embodiment embeds material data such as text and a still image into moving data to create a single moving-image file. In reproducing the moving image having the embedded material data, only the single file is needed. Thus, a moving image provided by the system according to the embodiment has a file configuration different from that of Flash video (composed of a plurality of files and serving as a moving image only when all those files are brought together). In addition, the system is expected to provide enhanced visual effects since the material data is moved in animation representation to improve the appearance.

A module for creating moving images is formed of two sections, that is, a program serving as an engine part for processing moving images and a script for controlling necessary elements. The system also includes a program for controlling the start of the program serving as the engine part. In response to provided parameters, and in accordance with processing described in the script (branching, specification of location, size, and transparency, and interruption of processing), the system according to the embodiment creates moving image by using moving-image elements (background moving images, text, images, and voice) to perform image synthesis for each moving-image frame.

The program according to the embodiment is provided not through an even-driven graphical user interface (GUI) operated in response to user's manual operations but through a command line interface (CLI). This allows operations to be registered in a scheduler and performed in batch processing without requiring user's manual operations, thereby enabling creation of moving images at remote locations without human intervention. The system according to the present embodiment can control the details of moving-image synthesis based on the previously provided script, so that the script can be given parameters, for example from a database, to achieve automatization. Since the script is text-based, users can directly modify or alter the script. When a user wishes to change the movement of material data within a moving image, the user can edit the script to alter the behavior easily. It should be noted that the user refers to anyone providing services, and more particularly, to a system operation manager or a system developer, but may refer to maintenance or inspection staff.

The embodiment described herein allows script control set for each parameter in order to reflect different parameters (personal attribute, personal information) for different individuals automatically in moving images. Depending on provided parameters, the script can switch background moving images to be read, text descriptions, or images to be read, or can change special effects in moving images. This can create moving images of varying contents, each for a different one of many users.

A preferred embodiment of the invention will hereinafter be described with reference to the accompanying drawings. FIG. 1 is a diagram showing an exemplary configuration of a video creation system according to the embodiment and data flow in the system. A video creation system 1 includes a business system 200, a database server 101, a data processing (manipulation) server 102, a video creation server 103, a storage apparatus 104, and a delivery server 105. Those units can transmit and receive data to and from each other over a network, not shown.

The business system 200 is a fundamental system responsible for merchandise inventory control, financial management, and input/output and management of personal data (including personal information and personal attribute data). The business system 200 is formed of a single or a plurality of servers. The business system 200 may be a system which includes a Web server and provides services over the Internet. Personal data directly input from service users or personal data provided on the basis of input values is accumulatively stored in the database server 101. The personal data includes personal information such as ID for management, name, age, gender, address, telephone number, and E-mail address, purchase history, and browsing history of product search. The database server 101 acquires those various types of personal data from the business system 200 and stores the data permanently. Although the database server 101 has a preinstalled Relational Database Management System (RDBMS) used to manage the personal data, another mechanism may be used to manage the data.

The data processing server 102 acquires data to be processed from the personal data accumulated in the database server 101 and processes the acquired personal data such that the video creation server 103 in a subsequent stage can process the data easily. The data processing server 102 extracts values to be embedded into moving-image data from the personal data. The data processing server 102 creates values to be used in subsequent moving-image data embedding based on values included in the personal data. The data processing server 102 transmits the extracted values and the created values to the video creation server 103. The detailed operation of the data processing server 102 is described later.

The video creation server 103 receives the personal data processed by the data processing server 102 and embeds the value of the personal data into a predefined moving image (hereinafter referred to as background moving image). The video creation server 103 also embeds a predefined still image into the background moving image. At the time of embedding, the personal data and the still image are given special effects for enhancing visual effects such as rotation, movement, enlargement/reduction, and changing transparencies. The video creation server 103 can also synthesize voice in the background moving image with a voice material.

The video creation server 103 creates moving-image data in a prescribed format so as to form a single file and transmits the created moving-image file associated with the personal data to the storage apparatus 104. The video creation server 103 is described later in detail.

The storage apparatus 104 is an external storage apparatus which receives and stores data over a network. Although the storage apparatus 104 is a Network Attached Storage (NAS) in this example, it may be a storage apparatus used in a Storage Area Network (SAN) or a file server. The storage apparatus 104 stores the moving-image data provided after embedding as a single file such that the moving-image file is associated with the personal data. The association is implemented in various manners, for example by including the identification information of the personal data in the file name of the moving-image file, by assigning the identification information of the personal data to the name of a folder and storing the moving-image file in the folder, or by using an association table. Although the present embodiment is configured to include the storage apparatus 104, an external cloud storage service may be used instead and the moving-image file is stored in the cloud.

The delivery server 105 is a server which delivers the moving-image files provided after embedding to service users. In response to a request from a service user, or as soon as a moving-image file is created, the delivery server 105 delivers the relevant moving-image file to the service user. The delivery server 105 performs Web-based delivery of moving images to a personal computer (PC) owned by the service user using an HTTP protocol or allows downloading of moving images. In addition, the moving-image file may be transmitted to a previously registered E-mail address.

Although the system in the above example is configured to have the individual servers in the separate housings, the system may be configured to have a parallel configuration including a plurality of servers in order to distribute processing loads. Alternatively, virtual machines may be utilized to reduce the number of server housings.

Alternatively, the storage apparatus 104 may not store the moving-image file, and upon a request from a service user, the video creation server 103 creates moving-image data in real time and transmits the created data directly to the delivery server 105, thereby achieving streaming delivery to the service user.

FIG. 2 is a diagram showing an exemplary internal configuration of the video creation server 103. The hardware configuration of the video creation server 103 is similar to that of an existing computer, and includes a processor 301 corresponding to a central processing unit, a memory 302 corresponding to a main storage apparatus, and a hard disk drive (HDD) corresponding to an auxiliary storage apparatus. The video creation server 103 also includes a network interface (IF) 304 for controlling communication with an external unit, a monitor 305, an input device 306 (such as a keyboard and a mouse), and a media read-out device 307. It should be noted that each of the data processing server 102 and the delivery server 105 also has a hardware configuration as shown in FIG. 2.

The HDD 303 previously stores programs for implementing aspects of the embodiment. In this example, the HDD 303 previously stores programs including a service module 311 and a video creation engine 312. These programs are installed, for example, by the media read-out device 307 reading an external media 320 for install (such as a CD-ROM or a DVD) and storing the read program in the HDD 303 or by downloading the program via the network IF 304 and storing the downloaded program in the HDD 303.

The service module 311 stored in the HDD 303 is a program which controls, with flag data, progress information indicating which personal data is waiting for processing, is being processed, or has been processed (processing completed), and passes necessary parameters to the video creation engine 312 to start up the engine 312. The progress information is managed in this example by setting a column for flag management in a table which stores the personal data in the database server 101 and updating the flag value.

The video creation engine 312 is started up by the service module 311 and embeds material data including text and still images based on a script 313. The video creation engine 312 performs the embedding according to the description of the script 313 such that the material data moves within the background moving image.

The script 313 is an instruction code described in a language learned more easily, for example than a machine language, and is a text file. A user can directly edit the script 313 since it is the text file. Specifically, the user can directly modify or alter the behaviors of the material data within the moving image. A plurality of scripts as described above may be created and installed in the HDD 303.

FIG. 3 is a flow chart showing an exemplary operation of the data processing server 102. The flow chart of FIG. 3 is described assuming that the data processing server 102 operates. In reality, however, the operation is achieved by a processor within the data processing server 102 deploying a program or data previously stored in an auxiliary storage apparatus (such as an HDD) to a memory and performing computation.

The data processing server 102 extracts, from the database server 101, a group of personal data to be used in moving-image creation (S001). The data processing server 102 refers to a progress information flag of each personal data (indicating “waiting for processing,” “being processed,” or “processing completed”) stored in the database server 101 to extract the group of personal data waiting for processing. The data processing server 102 further extracts one personal data item from the extracted group of personal data (S002) and analyzes the extracted personal data. The analysis includes the processing of extracting data to be embedded actually into a moving image or the processing of creating a value to be used in subsequent embedding into moving-image data based on a value included in the personal data. The value to be used in embedding into moving-image data is, for example, an actually obtained value such as a purchase price, a value determined through certain processing, and classification data related to the personal data. Specific examples of the classification data include categorized data including gender, occupation, age group, living area, and type of products purchased or browsed (for example, categories such as clothing, merchandise, and foods, or subdivided items). The script 313 in the video creation server 103 allows conditional branching control such that material data can be moved differently for different individuals or material data can be varied for different individuals in accordance with the actually obtained value, the value determined through processing, or the categorized data.

The data processing server 102 manipulates the data resulting from the analysis and necessary for moving-image creation into unified personal data (S004) and outputs the data to the video creation server 103 (S005). By way of example, for incorporating the name of a service user into a moving image, the name is the necessary data, or for incorporating a purchased product into a moving image, the name of the purchased product or its identification information is the necessary data. For reasons of management or script processing, the user ID of the service user and the categorized data are also the necessary data. In data output at step S005, the processed data may be transmitted directly to the video creation server 103 when the processed data is created, or the processed data may be stored as a file in the auxiliary storage apparatus (the data may be managed in an RDBMS) and the data in the file may be transmitted to the video creation server 103 as required. The video creation server 103 once accumulates the received data in a buffer area.

The data processing server 102 repeats the processing from S002 to S005 (loop from No at S006) until no personal data to be processed remains, and when no personal data remains (Yes at S006), the processing ends.

Next, FIG. 4 is a flow chart showing an exemplary operation of the video creation server 103. The flow chart of FIG. 4 is also described assuming that the video creation server 103 operates. In reality, however, the operation is achieved by the processor 301 shown in FIG. 2 deploying the service module 311, the video creation engine 312, the script 313, and the data previously stored in the HDD 303 to a memory and performing computation. The steps from S101 to S105 in FIG. 4 are implemented by execution of the service module 311, and the steps from S201 to S217 are implemented by execution of the video creation engine 312 and use of the script 313.

The video creation server 103 extracts, from the buffer, a group of personal data after processing transmitted from the data processing server 102 (S101). The video creation server 103 extracts processed data for one person based on the user ID of a service user (S102) and starts up the video creation engine 312 to perform moving-image creation processing (S103). After the moving-image creation processing is finished, the video creation server 103 attempts to acquire the next user ID (S104). When it is not acquired, the processing ends (Yes at S105). When it is acquired, the steps from S102 to S104 are performed on the basis of the acquired user ID (loop from No at S105).

Next, the moving-image creation processing at step S103 is described in detail. The video creation server 103 initializes and loads the script 313 in accordance with code commands from the video creation engine 312 (S201). In this case, the video creation server 103 specifies a directory in which the script is located, reads the script name and environment variables necessary for executing the script, and loads the script 313 into the memory 302. The video creation engine 312 executes the script 313 (S202). The subsequent steps from S203 to S216 are operations performed in accordance with the codes of the script 313.

The video creation server 103 reads a background moving image (S203). Although the background moving image is previously stored in the HDD 303 in this example, the background moving image maybe stored in an external apparatus, for example in the storage apparatus 104 and read out from that apparatus. The video creation server 103 divides the read background moving image into still images (frames) and acquires one frame to be processed (S203). The frame rate (fps) corresponding to the number of frames per unit time is defined in the script 313. Thus, the user can specify the frame rate in the script 313. The frame rate is 20 fps in this example. The video creation server 103 performs the frame division such that 20 frames corresponds to one second, and acquires one frame to be processed. In the following description, to avoid confusion with still images of material data, the still image of the background moving image is referred to as a frame and the still image of the material data is referred to as a material image.

The video creation server 103 reads the material image from the HDD 303 or an external apparatus (S205) and performs synthesis by embedding the material image appropriate for the frame to be processed into the frame (S206). The video creation server 103 reads text (S207) and performs synthesis by embedding the appropriate text into the frame acquired at step S205 (S208). The text data is the received personal data after processing (manipulation), and for example, includes text data such as the service user name or the purchased product name. It should be noted that which material data is embedded into which frame is specified by conditional branching control within the script 313 or by a parameter passed to the script 313.

The video creation server 103 divides voice data included in the background moving image into segments and acquires one of the voice data segments (S209). One segment corresponds to a time period from one frame to another, and the video creation server 103 divides voice data at intervals of 1/20 seconds in this example. The video creation server 103 reads a voice material file from the HDD 303 or an external apparatus (S210) and divides the voice material data into segments (S211). The video creation server 103 synthesizes voice data (one segment) from the background moving image and voice data (one segment) from the voice material file (S212). It should be noted that which voice data segment of the voice material file is combined with which voice data segment of the background moving image is specified by conditional branching control within the script 313 or by a parameter passed to the script 313.

The video creation server 103 encodes the synthesized voice data segment in a prescribed format (such as AAC or Vorbis) (S213). The video creation server 103 integrates the encoded voice data segment provided at S213 into the synthesized frame provided at step S208 and encodes the resulting data in a prescribed moving-image format (for example, MPEG4, VP8, or VP9) (S214). The moving-image data created at this point is moving-image data in which one voice data segment is integrated into one frame. The video creation server 103 outputs the encoding result as a file to a temporary area of the HDD 303 or the storage apparatus 104 (S215). The video creation server 103 determines whether or not the final frame is reached (S216), and when not reached (No at S216), increments the frame number for processing by one and returns to the processing at S203. The file outputs at S215 in the second and subsequent rounds are additionally stored in the file created for storing the encoding result. When the final frame is reached (Yes at S216), the video creation server 103 ends the script operation (S217).

The processing from S201 to S217 creates a segmented moving-image file for each frame, and each created file is output and added to create unified data. Alternatively, a segmented file is created in each loop from S201 to S216, and then the created files are integrated at the end.

FIG. 5 shows an exemplary operation for outputting the data created as described above in the form of one moving-image file of a prescribed format. The video creation server 103 acquires the file resulting from the text synthesis, image synthesis, and voice synthesis through the processing from S201 to S217 in FIG. 4 (ACT401). The video creation server 103 sets an output format (S402) and decodes the data in the set format (S403). In this example, the data is decoded in the format such as MPEG4, VP8, or VP9, and which format should be used is defined previously. Any format other than MPEG4, VP8, or VP9 may be used. The video creation server 103 finally outputs the file (S404) and ends the operation. After the operation in FIG. 5 is performed, the processing transitions to S104 in FIG. 4.

Next, synthesis processing performed on a background moving image is illustrated with reference to FIG. 6 to FIG. 14. FIG. 6 shows an example in which the material data of a character string “text” is embedded into each frame having a frame number 3 or greater of a background moving image. The script 313 allows conditional branching based on an if statement. The video creation server 103 determines whether or not the frame number is equal to or larger than 3 based on the if statement to embed the character string “text” into each frame having the frame number 3 or later.

As shown in FIG. 7, the script 313 allows parameters to be used to specify the font, size, character color (full color covering 256 levels for each of R, G, and B), flush right, and flush left in creating objects of text data. In the script 313, a condition determination (if statement) for determining the number of a frame being processed may be described, and different object parameters may be specified for different frames such that the character color varies or the font size gradually increases (or reduces) with progression of the moving image, for example.

FIG. 8 is a diagram for explaining the specification of location of text data and the specification of transparency of text data in the background moving image (frame). They can also be specified in creating objects of text data in the script 313. In this example, as shown in FIG. 8(A), the central position of the background moving image is set at reference coordinates (0, 0). When the background moving image has a horizontal size of 640 pixels and a vertical size of 480 pixels, four corners have coordinates (−320, 240), (320, 240), (−320, −240), and (320, −240). The video creation server 103 uses the reference coordinates and the coordinate axes to set the location where the text is placed. The video creation server 103 specifies coordinates for creating an object of text data and synthesizes the text and a frame such that the text object is centered on the specified coordinates (see FIG. 8(B)). A conditional branch based on the frame number may be described in the script 313, and each frame may be drawn on different coordinate axes to allow text data to appear to slide in vertical, horizontal, and oblique directions in the moving image. The transparency of a text image may be specified in a range from 0% to 100%.

The synthesis of text data described in FIG. 6 to FIG. 8 may be combined with each other. A text object requiring particular emphasis can be controlled to make effective movements in the moving image that appeal to vision. An if statement can be used within the script 313 to vary the font size, character color, location, or transparency depending on data obtained from the personal data including the user ID and the categorized data analyzed by the data processing server 102 such as the gender, occupation, age group, living area, and type of products purchased or browsed, in addition to the frame number.

Next, synthesis through embedding of a still image into a background moving image (frame) is described. FIG. 9 shows an example in which a still image is embedded into each frame having a frame number 3 or greater of a background moving image. Similarly to the above example, a conditional branch based on an if statement relating to the frame number can be described in the script 313 to embed the still image into each frame having the specified frame number or greater. The still image of material data is an image file for which an alpha channel can be set. In creating a still image object within the script 313, the video creation server 103 embeds the still image such that the marginal area is transparent.

FIG. 10 is a diagram for explaining the embedding of different still images depending on conditions. A plurality of still images are prepared in advance, and the script 313 specifies one image to be embedded from the plurality of images in accordance with a conditional branch. For example, the script 313 includes code descriptions for comparing, based on if statements, data obtained from the personal data including the user ID and the categorized data analyzed by the data processing server 102 such as the gender, occupation, age group, living area, and type of products purchased or browsed. This allows the video creation server 103 to embed a still image satisfying the conditions into a moving image.

In an example application, numerical value data may be plotted in a graph or distribution chart which may be embedded as a still image into a moving image. As a matter of course, the graph or distribution chart can be animated.

As shown in FIG. 11, the still image may be specified in terms of enlargement/reduction, location, rotation, and transparency, and those specifications maybe combined. The specifications are made for still image objects within the script 313. The still image can be embedded into respective frames such that different specification values are used depending on the frame number or personal data according to conditional branching. This allows the video creation server 103 to control the movement of still images.

For example, the movement can be controlled such that gradually increased still images are shown to create a moving image which looks as if the still images come closer to a viewer, or such that still images having gradually changing transparencies can be shown to make the still images fade in or fade out with the background moving image remaining displayed. Such control can be applied to the text data described in FIG. 6 to FIG. 8. Such effects can also be described in the script 313 to allow the user to set any operations.

FIG. 12 is a diagram for explaining a method of synthesizing voice in the background moving image and voice to be synthesized (referred to as voice material). In the example of FIG. 12, the voice in the background moving image from the third frame to a point immediately before the fifth frame is fragmented and extracted, and the fragmented voice and the voice material are synthesized. The fragmented voice after the synthesis is returned to the original background moving image. Voice from which frame should be extracted can be specified within the script or by a parameter passed to the script 313.

As shown in FIG. 13, the voice synthesis can also use an if statement to change voice materials to be embedded depending on conditions. For example, conditional branching can be implemented according to the value of personal data. A plurality of voice files (voice files A and B in the example of FIG. 13) serving as voice materials are prepared in advance, and the video creation server 103 controls which voice file and the background moving-image voice should be synthesized in accordance with the conditional branch within the script 313.

Moving images unified in a finalized form to be provided for the service user (herein referred to a content moving image) are often formed of a plurality of scenes. In the present embodiment, divided background moving images for respective scenes may be created in advance and they may be combined finally. FIG. 14 shows an example in which two divided background moving images including a background moving image A (moving image of a car) and a background moving image B (moving image of a bicycle) are provided in advance. The embodiment involves combining the two moving images into a single content moving image. Text data or a still image to be embedded may be defined within the script 313 in accordance with identification information of each divided background moving image, and the identification information of each divided background moving image may be used as a condition, thereby allowing different embedded material data or different movements to be applied to different divided background moving images.

In an example application of scene switching, a transition effect may be given. For example, a preceding scene may be slid and switched to a subsequent scene, or may be switched to a subsequent scene as if a page is turned.

Next, FIGS. 15 to 17 show an example of the script 313. The script shown in FIGS. 15 to 17 is a single series of scripts. “- - ” indicates a comment statement.

### (Parameter Setting)

Encode parameters are set in rows 0001 to 0004. Specifically, a frame width, a frame height, a frame rate (fps), a bit rate of a moving image to be output are set.

In rows 0005 to 0009, a sampling rate of voice to be output, a quantization bit number, the number of channels (analog/stereo), a bit rate, a delay (delay sampling number to moving image) are set.

The subsequent INITIALIZE function and COMPOSE function are called from the video creation engine 312 and are essential functions.

### (INITIALIZE Function)

This is a function for frame initialization and moving-image part initialization and is called only once before encode is started.

### (COMPOSE Function)

This is a function called each time frame drawing or sound synthesis is performed. In this example, add_part_a function is called when the number of moving-image parts to be processed is zero (for example, background moving image A in FIG. 14), or add_part_b function is called when the number of the moving-image part is one (for example, background moving image B in FIG. 14). The value of a variable “frame” is passed as an argument to the COMPOSE function.

(add_part_a fuction)

This is a function called from the COMPOSE function and corresponds to processing of a part for adding a specified moving-image material to a moving image to be output. In this case, part_a.wmb is added to the moving image to be output.

(add_part_b function)

This is a function called from the COMPOSE function and corresponds to processing of a part for adding a specified moving-image material to a moving image to be output. In this case, part_b.wmb is added to the moving image to be output.

Functions used in add_part_function and add_part_b function are listed in the following.

SOURCE.open (type, resource, params)

This function opens an input resource and returns a handle for subsequent reading. In “type”, a moving image (movie), serial number image (animation), still image (image), text (text), and sound (sound) can be specified. For the text type, a particular character string, font type, size, transparency and the like are set in this function.

FRAME.compose (source, x, y)

This function synthesizes an input image specified by “source” in a buffer. The position is specified by x, y. For example, when a moving-image frame is put into a buffer and then a text is put thereto, the moving-image frame and the text are synthesized.

FRAME.multiplex(source)

This function superposes fragmented voice specified by “source” in a sound buffer for mixing. Nothing is mixed when “source” is not a voice file.

SOURCE.alpha(source,alpha)

This function sets the transparency of an image specified by “source.”

SOURCE.next(source)

This function advances one frame of a resource specified by “source”.

SOURCE.close(source)

This function closes a resource specified by “source” and releases a program resource.

SOURCE.angle(source,degree)

This function rotates a resource specified by “source” to an angle specified by “degree.”

SOURCE.scale (source, ratio)

This function enlarges/reduces a resource specified by “source” at a rate specified by “ratio.”

SOURCE.rewind (source)

This function locates the start of “source.”

Although the above example mainly describes a merchandise sales system as an example, the present invention is applicable to a system which has other applications. Examples thereof are described below.

### (Physical Examination Result Provision System in Medical Institution)

This system incorporates the name of a person undergoing a physical examination, the date, the medical institution, and the plan for physical examination into a moving image and displays the numerical values of the respective test items of the physical examination in graph form. In the graph, the same item can be represented over time or on the time series.

### (Skin Check System in Cosmetics Maker)

The system of the above embodiment is implemented as a system which shows the result of skin check of a service user to propose recommended cosmetics. Based on the results of a questionnaire and skin check using a special machine, the system incorporates the skin check results uniquely organized by the Maker including moisture retention, elasticity, and skin roughness into a moving image in the form of numerical values, tables, and attributes. The system also proposes recommended cosmetics in the moving image based on the skin conditions.

### (Supplement Suggestion System in Health Food Company)

The system of the above embodiment is implemented as a system which shows the result of lifestyle habit check to propose recommended supplements. A questionnaire is used to survey lifestyle habits related to the effects of a supplement such as diet, metabolism, blood circulation, stress, and fatigue. The system incorporates the indexes of the check items requiring special cares into a moving image. The system also proposes recommended supplements in the moving image.

### (Course Guidance System in Preparatory School)

The system of the above embodiment is implemented as a system which shows the result of a practice examination to propose recommended lesson plans. The system displays the national-level result of a practice examination for each subject or each category and incorporates the probability of passing a desired university into a moving image. The system also proposes recommended courses in the moving image.

### (System for Providing Result of Necessary Insurance Determination in Life Insurance Company)

A questionnaire is used to survey family makeup (relationship and ages), savings, income information, and living costs, and the system incorporates the necessary insurance for the family into a moving image. The system provides a plan for life cycle design and stimulates the need for insurance.

### (Reserved Tour Conformation and Guidance System in Travel Agency)

This system shows details of a reserved tour (including destination, flight date and time, airport, number of participants, hotels for stay, and additional options) in a moving image, and creates the moving image so as to show things to keep in mind before the day of the tour and necessary procedures. The system also incorporates a guide for a local optional tour into the moving image.

### (System for Conforming Plan Details and Showing Additional Options in Wireless Carrier)

This system shows, in a moving image, the conformation of plan details and additional options for a person who has subscribed to a new plan. The system displays the details of the plan subscribed to (including plan name, free talk time, available data amount, and applied discount) and the details of additional options (including answering-machine service and compensation service) together with their prices, and proposes additional recommended options.

### (System for Proposing Continuous Taking of Course or Taking of Higher Level Course in Aesthetic Salon, Training Gym, and English Conversation School)

This system shows, in a moving image, the details of the currently applied course (including course name, number of scheduled lessons, and details of lessons) and the actual situations of the course (including the number of lessons, date, and use of additional options), shows any changes (in skin condition, weight, or English level) during the course period, and proposes continuous taking of the course or taking of a higher level course.

### (System for Proposing Renewal of Automobile Insurance)

This system creates a moving image in which the conditions of a present contract (such as expiration date, grade, age limit, gold licensee included, and term of contract) and the details of insurance (such as insurance amount and special contract) are explained for each item. The system presents an estimate of a renewal based on the details of the present contract and an estimate of a recommended plan in the moving image.

### (Performance Appraisal and Business Management System)

With visual representation of the whole picture or evaluation axis of a grading system or core competency, this system shows the rank or level of a person and highlights or plots the associated sections. The system feeds back the statuses of sales indicators (including the number of visits, number of proposals, number of contracts established, and the amount of contracts) for each person, and displays, in a moving image, the conditions of the whole company and the office which the person belongs to. The display is performed with special effects produced by graphics such as a plot and a stamp representing the accomplishment level, in addition to numerical values.

### (System for EC Shopping Mall Operating Company)

For example, the system according to the embodiment is implemented in a system which recommends a shop to continue the contract of operation. In the recommendation of the continuing contract, the system creates a moving image which shows comparisons of the sales status (including sales and number of sells), activities (including the number of delivered mail magazines and posted advertisements), and efficiency (including conversion rate and customer unit) with other companies in the same business. The system indicates important points for increasing the sales in the moving image.

### (System for Cloud Account Software Provider)

This system provides monthly account highlights in a moving image. The system incorporates basic account information such as sales, selling, general and administrative expenses, and recurring profit as highlights into the moving image. In addition to the single-month status, the system may incorporate monthly movements, cumulative total, and the level compared to the same month the year before into the moving image.

### (System for Agency System Holding Company)

This system incorporates the status of each agent (including total sales, sales for each item, and monthly status) into a moving image, and incorporates the national-level status and local comparisons.

The embodiment has been described in conjunction with creation of moving-image files of one of the prescribed formats used typically, instead of Flash video. The Flash video has a file configuration in which a background moving image is separate from information such as text, and serves as a moving image only when all those files are brought together. Thus, the reproduction of Flash video requires a plurality of files, and the folder configuration is specified, so that file handling is inconvenient, for example during download. In addition, since the Flash video involves synthesis of characters and images during reproduction, the processing is complicated and cooperation with another external system is difficult even when a reproduction player is provided. For these and other reasons, the Flash video can be reproduced only on a dedicated player or a dedicated plug-in for Web browsers.

In contrast, the moving-image data provided according to the embodiment is created as a single file which can be reproduced on a player attached to the OS or a Web browser. This makes file handling such as downloading easier than in the Flash video configured to include a plurality of files. The moving-image data created according to the embodiment can be reproduced on a typical reproduction device such as a smartphone, game device, and music/moving-image player. The single moving-image file facilitates cooperation with an external system (such as a mail delivery system, CMS, and SNS).

Since the embodiment embeds text information or the like into a single moving-image file and encodes it as moving-image data, tampering of the embedded information is hardly performed. For example, even when a third party invades the server, tampering of the text information such as personal data is extremely difficult.

As described above, the aspect of the embodiment allows the presentation of information in the form of moving-image data with enhanced visual effects which make a strong impression on the service user. The embedding of the personal data of the service user can create the personalized and familiar moving-image data. Since the single moving-image file is created, file handling is facilitated as described above and tempering of information is difficult.

Since the script editable on a text basis is used to control the embedding of material data, the details of a presented moving image can be easily changed during system operation. In addition, the behavior of material data can be varied in accordance with the branch conditions such as if statements within the script, so that customized moving images can be provided suitably for the respective service users.

### DESCRIPTION OF THE REFERENCE NUMERALS

1 video CREATION SYSTEM, 101 DATABASE SERVER, 102 DATA PROCESSING SERVER, 103 video CREATION SERVER, 104 STORAGE APPARATUS, 105 DELIVERY SERVER

200 BUSINESS SYSTEM

301 PROCESSOR, 302 MEMORY, 303 HDD, 304 NETWORK IF, 305 MONITOR, 306 INPUT DEVICE, 307 MEDIA READ-OUT DEVICE, 311 SERVICE MODULE, 312 video CREATION ENGINE, 313 SCRIPT, 320 EXTERNAL MEDIA

1: A video creation server comprising:
an acquisition section configured to acquire material data including one or both of text data and a still image; and
a control section configured to acquire a script code editable by a user and to create moving-image data having the material data embedded into each frame of previously defined moving-image data such that the material data moves within the previously defined moving-image data in accordance with the script code.

2: The video creation server according to claim 1, wherein the previously defined moving-image data corresponds to a plurality of divided moving-image data items provided for respective scenes, and
the control section is configured to embed the material data into each of the divided moving-image data items in accordance with the script code and to integrate the divided moving-image data items having the embedded material data into moving-image data.

3: The video creation server according to claim 1, wherein the control section is configured to create the moving-image data having the embedded material data as a single file in a prescribed format.

4: The video creation server according to claim 1, wherein the text data includes personal data, and
the control section is configured to embed material data of the personal data into the moving-image data such that the material data moves in accordance with the script code.

5: The video creation server according to claim 1, wherein the script code includes a code for executing a conditional branch, and
the control section is configured to embed the material data into the moving-image data such that one or both of the material data and movement of the material data vary in accordance with the conditional branch within the script code.

6: The video creation server according to claim 1, wherein the control section is configured to create the moving-image data in which voice material data and voice data of the previously defined moving-image data are synthesized.

7: A video creation program for causing a computer to perform processing comprising:
acquiring material data including one or both of text data and a still image;
acquiring a script code editable by a user; and
creating moving-image data having the material data embedded into each frame of previously defined moving-image data such that the material data moves within the previously defined moving-image data in accordance with the script code.

8: A video creation method comprising performing, by a computer, processing of:
acquiring material data including one or both of text data and a still image;
acquiring a script code editable by a user; and
creating moving-image data having the material data embedded into each frame of previously defined moving-image data such that the material data moves within the previously defined moving-image data in accordance with the script code.

9: A video creation system comprising:
a first server configured to acquire material data including one or both of text data and a still image, and
to acquire a script code editable by a use and to create moving-image data having the material data embedded into each frame of previously defined moving-image data such that the material data moves within the previously defined moving-image data in accordance with the script code; and
a second server configured to acquire the moving-image data having the embedded material data created by the first server and to deliver the moving-image data to a provider of personal data included in the moving-image data.

10: The video creation system according to claim 9, further comprising:
a third server configured to acquire personal data to be processed from a storage section accumulatively storing personal data, to extract a value to be embedded into the moving-image data from the acquired personal data or create a value to be used in embedding into the moving-image data based on a value included in the acquired personal data, and to transmit these values as personal data to the first server,
wherein the first server is configured to receive the personal data transmitted from the third server.
